(19) United States
(12) Patent Application Publication
(10) Pub. No.: US 2016/0294015 A1
(43) Pub. Date: Oct. 6, 2016

(54) SECONDARY BATTERY AND PRODUCTION METHOD THEREFOR

(71) Applicant: NEC ENERGY DEVICES, LTD., Sagamihara-shi, Kanagawa (JP)

(72) Inventors: Shin TANAKA, Kanagawa (JP); Masaaki MATSUU, Kanagawa (JP)

(73) Assignee: NEC ENERGY DEVICES, LTD., Sagamihara-shi, Kanagawa (JP)

(21) Appl. No.: 15/036,122

(22) PCT Filed: Nov. 12, 2014
(86) PCT No.: PCT/JP2014/079965

§ 371 Date: May 12, 2016

(30) Foreign Application Priority Data
Dec. 12, 2013 (JP) 2013-257197

(51) Int. Cl. H01M 10/0585; H01M 10/0525; H01M 2/02; H01M 4/36; H01M 2/34

(52) U.S. Cl. CPC H01M 10/0585; H01M 4/366; H01M 2/34; H01M 2/0277; H01M 10/0525

(57) ABSTRACT

A secondary battery includes an assembly with positive and negative electrodes alternately laminated with a separator interposed therebetween, each of the electrodes includes an active material layer formed on a current collector. The active material layer has a multi-layer structure that includes first and second active material layers, all or part of a second active material layer being positioned on the first active material layer, termination positions of the active material layers being deviated in a planar direction. Insulting member is disposed to cover a border part between applied and non-applied parts of the active material layer. A difference between an average thickness at a multi-layer part where both active material layers are laminated on current collector and a thickness of the active material layer at a part where the insulating member is positioned on active material layer is 50% or more of a thickness of the insulating member.

### TECHNICAL FIELD

The present invention related to a secondary battery in which a positive electrode and an negative electrode are overlapped with a separator therebetween, and a production method therefore.

### BACKGROUND ART

A secondary battery has been widely diffused as a vehicle or household electric power source, as well as an electric power source of a portable apparatus such as a mobile phone, a digital camera and a laptop computer. Above all, a lithium-ion secondary battery, which has high energy density and light weight, is an energy storage device that has become essential for daily life.

The secondary battery can be roughly classified into a wound type and a laminated type. A battery electrode assembly of the wound type secondary battery has a structure in which a long positive electrode sheet and a long negative electrode sheet are wound multiple times in a state of being overlapped with a separator interposed therebetween. A battery electrode assembly of the laminated type secondary battery has a structure in which the positive electrode sheets and the negative electrode sheets are laminated alternately and repeatedly while being separated by the separator. The positive electrode sheet and the negative electrode sheet each include an applied part where active material (including a mixture agent that contains a binding agent, a conductive material and the like) is applied on a current collector and a non-applied part where the active material is not applied for the connection with an electrode terminal.

In each of the wound type secondary battery and the laminated type secondary battery, the battery electrode assembly is contained in a sealed outer container (outer case), such that one end of a positive electrode terminal is electrically connected with the non-applied part of the positive electrode sheet and the other end is led out of the outer container while one end of an negative electrode terminal is electrically connected with the non-applied part of the negative electrode sheet and the other end is led out of the outer container. In the outer container, together with the battery electrode assembly, an electrolyte solution is contained in a sealed container. The secondary battery tends to have a larger capacity year after year, and thereby, if a short circuit occurs, heat generation becomes larger, resulting in increase in danger. Therefore, safety measures for the battery have become increasingly important.

As an example of the safety measure, Patent Document 1 discloses a technology of forming an insulating member on a border part between the applied part and the non-applied part to prevent the short circuit between the positive electrode and the negative electrode. Further, Patent Document 2 discloses a configuration in which the active material formed on the current collector has a multi-layer structure.

### PRIOR ART DOCUMENTS

### Patent Document

Patent Document 1: Japanese Patent Laid-Open No. 2012-164470

Patent Document 2: Japanese Patent Laid-Open No. 2010-262773

### SUMMARY OF INVENTION

### Problem to be Solved by the Invention

In the technology disclosed in Patent Document 1, as shown in FIG. 11, positive electrode 1 and negative electrode 6 are alternately laminated with separator 20 interposed therebetween, and insulating member 40 covering border part 4 between the applied part where active material 2 is applied and the non-applied part where active material 2 is not applied is formed on current collector 3 of positive electrode 1. In the laminated type secondary battery, insulating members 40 are repeatedly laminated at the same position, as viewed planarly. Therefore, at the part where insulating member 40 is disposed, the thickness of the battery electrode assembly partially increases and the energy density per volume decreases.

Further, in the secondary battery, for stabilizing electric characteristic and reliability, it is preferable to fix the battery electrode assembly with a tape or the like and apply uniform pressure to the battery electrode assembly. However, when the insulating member shown in Patent Document 1 is used in the laminated type secondary battery, it is not possible to apply uniform pressure to the battery electrode assembly, because of the difference in thickness between a part where insulating member 40 is present and a part where insulating member 40 is not present, and there is concern about causing the decrease in the quality of the battery, as exemplified by the variation in electric characteristic and the decrease in cycle characteristic.

In Patent Document 2, it is possible to prevent the damage to the separator and the occurrence of a short circuit within the battery due to the protrusion of an end part of the applied part of the active material. However, it is not possible to prevent an increase in the thickness of the battery electrode assembly that includes the insulating member and to prevent a decrease in the quality of the battery due to the impossibility of applying uniform pressure to the battery electrode assembly. To begin with, Patent Document 2 fails to take into consideration that the insulating member covers the border part between the applied part and the non-applied part for the active material. Therefore, the above-described disadvantage associated with the repeated lamination of the insulating members at the same position in the laminated type secondary battery as viewed planarly is not recognized at all.

Hence, an object of the present invention is to solve the above problem, and to provide a high-quality secondary battery with high electric characteristics and high reliability that reduces volume increase and deformation of the battery electrode assembly while preventing a short circuit between the positive electrode and the negative electrode by the insulating member, and a production method therefore.

### Means to Solve the Problem

A secondary battery in the present invention comprises a battery electrode assembly in which a positive electrode and an negative electrode are alternately laminated with a separator interposed therebetween, and each of the positive electrode and the negative electrode includes a current collector and an active material layer formed on the current collector. In any one or both of the positive electrode and the negative electrode, the active material layer has a multi-layer structure that includes a first active material layer and a second active material layer, a part or a whole of the second active material layer being positioned on the first active material layer, a termination position of the first active material layer and a termination position of the second active material layer being deviated in a planar direction. An insulting member is disposed so as to cover a border part between an applied part and a non-applied part, the applied part being a part where the active material layer is formed, the non-applied part being a part where the active material layer is not formed. A difference between an average thickness at a multi-layer part where both the first active material layer and the second active material layer are laminated on the current collector and a thickness of the active material layer at a part where the insulating member is positioned on the active material layer is 50% or more of a thickness of the insulating member.

### Advantageous Effects of Invention

According to the present invention, it is possible to reduce an increase in the volume of the battery electrode assembly and the distortion of the battery electrode assembly due to the insulating member, and therefore, it is possible to obtain a high-quality secondary battery having good energy density.

### BRIEF DESCRIPTION OF DRAWINGS

FIG. 1A is a plan view showing a basic structure of a laminated type secondary battery in the present invention.

FIG. 1B is an A-A line sectional view of FIG. 1A.

FIG. 2 is an enlarged sectional view showing a principal part of an exemplary embodiment of the secondary battery in the present invention.

FIG. 3A is an enlarged sectional view showing a positive electrode in an exemplary embodiment of the secondary battery in the present invention.

FIG. 3B is an enlarged view illustrating the actual shape of the positive electrode shown in FIG. 3A.

FIG. 4 is a plan view showing a positive electrode formation step of a production method for the secondary battery in the present invention.

FIG. 5 is a plan view showing a step following the step of FIG. 4 of the production method for the secondary battery in the present invention.

FIG. 6A is a plan view showing a step following the step of FIG. 5 of the production method for the secondary battery in the present invention.

FIG. 6B is a plan view showing a positive electrode that is formed by cutting in the step shown in FIG. 6A.

FIG. 7 is a plan view showing an negative electrode formation step of the production method for the secondary battery in the present invention.

FIG. 8A is a plan view showing a step following the step of FIG. 7 of the production method for the secondary battery in the present invention.

FIG. 8B is a plan view showing an negative electrode that is formed by cutting in the step shown in FIG. 8A.

FIG. 9 is a block diagram schematically showing an exemplary apparatus that is used for intermittent application of active material.

FIG. 10 is an enlarged sectional view showing a positive electrode in another exemplary embodiment of the secondary battery in the present invention.

FIG. 11 is an enlarged sectional view showing a principal part of a laminated type secondary battery in the related art.

### DESCRIPTION OF EMBODIMENTS

Hereinafter, exemplary embodiments of the present invention will be described using the drawings.

### Configuration of Secondary Battery

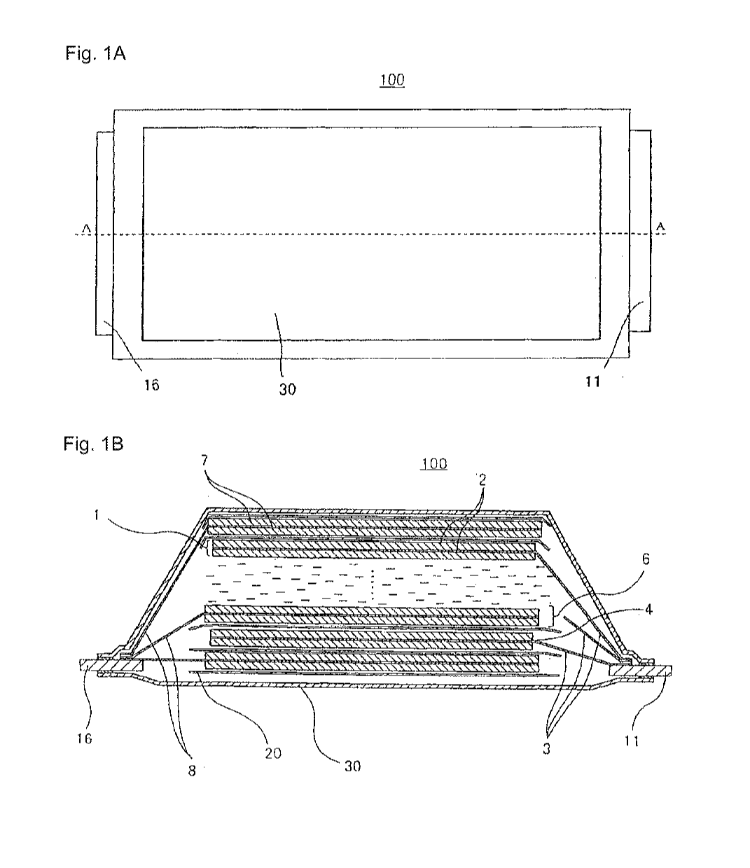

FIGS. 1A and 1B schematically show an exemplary configuration of a laminated type lithium-ion secondary battery that is produced by the production method in the present invention. FIG. 1A is a plan view as viewed from above perpendicular to a principal surface (flat surface) of the secondary battery, and FIG. 1B is an A-A line sectional view of FIG. 1A.

Lithium-ion secondary battery 100 in the present invention includes an electrode laminate body (battery electrode assembly) in which positive electrodes (positive electrode sheets) 1 and negative electrodes (negative electrode sheets) 6 are alternately laminated with separator 20 interposed therebetween such that layers are formed. The electrode laminate body is contained in an outer container formed of flexible film 30, together with an electrolyte solution. One end of positive electrode terminal 11 is connected with positive electrode 1 of the electrode laminate body, and one end of negative electrode terminal 16 is connected with negative electrode 6. The other end side of positive electrode terminal 11 and the other end side of negative electrode terminal 16 are each led out of flexible film 30. In FIG. 1B, the illustration of some (layers positioned at an intermediate part in the thickness direction) of the respective layers configuring the electrode laminate body is omitted, and the electrolyte solution is illustrated.

Positive electrode 1 includes current collector (positive electrode current collector) 3 for the positive electrode, and active material layer (positive electrode active material layer) 2 for the positive electrode applied on positive electrode current collector 3. On the front surface and back surface of positive electrode current collector 3, an applied part where positive electrode active material layer 2 is formed and a non-applied part where positive electrode active material layer 2 is not formed are positioned so as to be arrayed along the longitudinal direction. Similarly, negative electrode 6 includes current collector (negative electrode current collector) 8 for the negative electrode, and active material layer (negative electrode active material layer) 7 for the negative electrode applied on negative electrode current collector 8. On the front surface and back surface of negative electrode current collector 8, an applied part and a non-applied part are positioned so as to be arrayed along the longitudinal direction.

Each non-applied part of positive electrode 1 and negative electrode 6 is used as a tab for the connection with an electrode terminal (positive electrode terminal 11 or negative electrode terminal 16). Positive electrode tabs connected with positive electrodes 1 are collected on positive electrode terminal 11, and are connected with each other, together with positive electrode terminal 11, by ultrasonic welding or the like. Negative electrode tabs connected with negative electrodes 6 are collected on negative electrode terminal 16, and are connected with each other, together with negative electrode terminal 16, by ultrasonic welding or the like. Then, the other end of positive electrode terminal 11 and the other end of negative electrode terminal 16 are each led out of the outer container.

The external dimensions of the applied part (negative electrode active material layer 7) of negative electrode 6 are larger than the external dimensions of the applied part (positive electrode active material layer 2) of positive electrode 1, and are smaller than or equal to the external dimensions of separator 20.

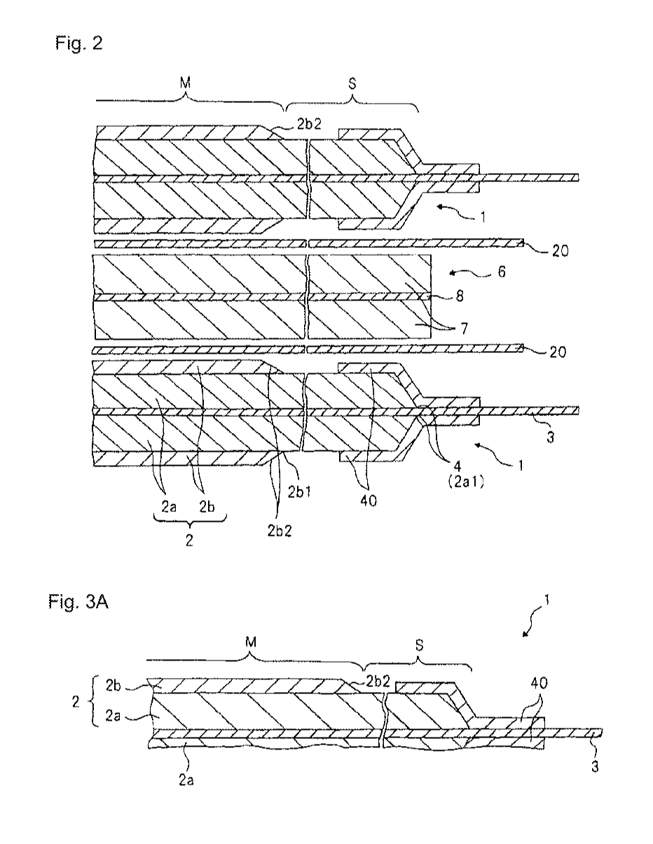

As shown in FIG. 2, in positive electrode 1 according to the exemplary embodiment, positive electrode active material layer 2 having a multi-layer structure is formed on both surfaces of positive electrode current collector 3. Specifically, an active material mixture agent for the positive electrode is applied on positive electrode current collector 3 so that first active material layer 2a is formed, and further, an active material mixture agent for the positive electrode is applied on first active material layer 2a so that second active material layer 2b is laminated. The positive electrode active material mixture agent of first active material layer 2a and the positive electrode active material mixture agent of second active material layer 2b may be the same, or may be different. In the exemplary embodiment, termination position 2a1 of the first active material layer 2a is closer to an outer edge of the battery electrode assembly than termination position 2b1 of second active material layer 2b. Therefore, positive electrode active material layer 2 includes multi-layer part M where both of first active material layer 2a and second active material layer 2b are laminated on positive electrode current collector 3, and single-layer part S where only first active material layer 2a is formed on positive electrode current collector 3, and the thickness of single-layer part S is smaller than the thickness of multi-layer part M. Then, second active material layer 2b includes slope part 2b2 that extends from a border part between multi-layer part M and single-layer part S.

Then, in order to prevent the occurrence of a short circuit with negative electrode terminal 16, insulating member 40 is formed so as to cover border part 4 between the applied part where positive electrode active material layer 2 is formed and the non-applied part where positive electrode active material layer 2 is not formed (in the exemplary embodiment, border part 4 coincides with termination position 2a1 of first active material layer 2a). Insulating member 40 is formed across both the non-applied part (positive electrode tab) and positive electrode active material 2 (in the exemplary embodiment, first active material layer 2a at the single-layer part of positive electrode active material layer 2), so as to cover border part 4. At the part where insulating member 40 is positioned on positive electrode active material layer 2, the sum of the thickness of positive electrode active material layer 2 (single-layer part S formed of first active material layer 2a) and the thickness of insulating member 40 is smaller than the average thickness of positive electrode active material layer 2 at multi-layer part M. Thus, positive electrode 1 is not thick in part at the location where insulating member 40 is disposed. In FIG. 2, for convenience of viewing, positive electrode 1, negative electrode 6 and separator 20 are drawn such that they are not in contact with each other, but in fact, they are tightly laminated so that they are in actual contact with each other.

Next, a detailed configuration of positive electrode active material layer 2 will be described with reference to FIGS. 3A and 3B. In the exemplary embodiment, as described above, there is provided slope part 2b2 that extends from the border position between multi-layer part M and single-layer part S of positive electrode active material layer 2 to the part with the average thickness of multi-layer part M. Slope part 2b2 is provided at an end part of second active material layer 2b, and the average angle with respect to positive electrode current collector 3 is 20 degrees or greater, and more preferably, is 25 degrees or greater. Actually, as shown in FIG. 3B, the surfaces of positive electrode current collector 3 and positive electrode active material layer 2 each have some degree of unevenness, and the outlines are not perfectly straight lines. Therefore, the angel between the slope part 2b2 and positive electrode current collector 3 varies somewhat depending on measurement position. Hence, as the average angle, it is specified herein that angle a between a straight line roughly parallel to the surface of positive electrode current collector 3 and a straight line roughly parallel to the surface of slope part 2b2 is 20 degrees or greater (preferably 25 degrees or greater). It is preferable that the length of slope part 2b2 along the longitudinal direction of positive electrode current collector 3 be 0.2 mm or less.

In the specific example shown in FIGS. 3A and 3B, the average thickness of first active material layer 2a is 0.1 mm, and the average thickness of second active material layer 2b is 0.04 mm. Accordingly, the average thickness of multi-layer part M is 0.14 mm. The length of slope part 2b2 along the longitudinal direction of positive electrode current collector 3 is 0.06 mm, and the length of single-layer part S along the longitudinal direction of positive electrode current collector 3 is 1 mm. Then, the thickness of insulating member 40 formed across single-layer part M and the non-applied part is 0.03 mm. In the configuration, at the part where insulating member 40 is positioned on positive electrode active material layer 2, the sum of the thickness of positive electrode active material layer 2 (single-layer part S formed of first active material layer 2a) and the thickness of insulating member 40 is 0.13 mm, and is smaller than the average thickness (0.14 mm) of multi-layer part M of positive electrode active material layer 2. Thus, positive electrode 1 is not thick in part at the location where insulating member 40 is disposed. Therefore, it is possible to reduce the decrease in energy density per volume and to apply uniform pressure to the battery electrode assembly, and it is possible to prevent a decrease in the quality of the battery, as exemplified by the variation in electric characteristic and by a decrease in cycle characteristic. Here, slope part 2b2 and single-layer part S are lower in density than multi-layer part M. Here, although omitted in the description and the drawings, an intermediate layer is sometimes interposed between first active material layer 2a and second active material layer 2b. Although the intermediate layer can be present on the surface of first active material layer 2a, for convenience, the layer in such a configuration is referred to as “single-layer part S”, herein.

In negative electrode 6 according to the exemplary embodiment, negative electrode active material layer 7 that is a single layer is formed on both surfaces of negative electrode current collector 8, and insulating member 40 is not provided.

In the secondary battery according to the exemplary embodiment, as the active material composing positive electrode active material layer 2, for example, layered, oxide-based materials such as LiCoO₂, LiNiO₂, LiNi₍₁₋ₓ₎CoO₂, LiNiₓ(CoAl)₍₁₋ₓ₎O₂, Li₂MO₃—LiMO₂ and LiNi_{1/3}Co_{1/3}Mn_{1/3}O₂, spinel materials such as LiMn₂O₄, LiMn_{1.5}Ni_{0.5}O₄ and LiMn₍₂₋ₓ₎MₓO₄, olivine materials such as LiMPO₄, olivine fluoride materials such as Li₂MPO₄F and Li₂MSiO₄F, and vanadium oxide materials such as V₂O₅ can be used, and mixtures of two or more kinds of them can also be used.

As the active material composing the negative electrode active material layer 7, carbon materials such as graphite, amorphous carbon, diamond-like carbon, fullerene, carbon nanotube and carbon nanohorn, or the like, lithium metal material, alloy materials of silicon, tin, and the like, oxide materials such as Nb₂O₅ and TiO₂, or composites of them can be used.

The active material mixture agent that forms positive electrode active material layer 2 and negative electrode active material layer 7 is an agent in which a binding agent, a conductive assistant and the like are appropriately added in the above-described active material. As the conductive assistant, carbon black, carbon fiber, graphite and the like can be used and combinations of two or more kinds of them can also be used. Further, as the binding agent, polyvinylidene fluoride, polytetrafluoroethylene, carboxymethyl cellulose, denatured acrylonitrile rubber particles and the like can be used.

As positive electrode current collector 3, aluminum, stainless steel, nickel, titanium, and the like can be used, and alloys of them can also be used. Aluminum is particularly preferable. As negative electrode current collector 8, copper, stainless steel, nickel, and titanium can be used, and alloys of them can also be used.

As the electrolyte solution, one of organic solvents can be used, as exemplified by cyclic carbonates such as ethylene carbonate, propylene carbonate, vinylene carbonate and butylene carbonate, chain carbonates such as ethyl methyl carbonate (EMC), diethyl carbonate (DEC), dimethyl carbonate (DMC) and dipropyl carbonate (DPC), aliphatic carboxylates, γ-lactones such as γ-butyrolactone, chain ethers, and cyclic ethers, and mixture of two kinds of them can also be used. Furthermore, a lithium salt can be dissolved in the organic solvents.

Separator 20 is mainly formed of a plastic porous membrane, woven fabric or non-woven fabric, or the like. As the resin component, for example, polyolefin resin such as polypropylene and polyethylene, polyester resin, acrylic resin, styrene resin, nylon resin and the like can be used. Particularly, a polyolefin-based microporous membrane is preferable because it has excellent ion permeability properties and because it provides excellent separation between the positive and negative electrodes. Further, as necessary, a layer containing inorganic particles may be formed in separator 20. As the inorganic particle, there are insulating oxide, nitride, sulfide, carbide, and the like, and above all, it is preferable to contain TiO₂ or Al₂O₃.

As the outer container, a case formed of flexible film 30, a can case, or the like can be used, and from the standpoint battery weight reduction, it is preferable to use flexible film 30. As flexible film 30, a film in which a resin layer is provided on the front and back surfaces of a metal layer that is a substrate can be used. As the metal layer, a metal layer having barrier property can be selected, for example, to prevent leakage of the electrolyte solution and prevent the intrusion of moisture from the exterior, and aluminum, stainless steel and the like can be used. At least one surface of the metal layer is provided with a thermal bonding resin layer of a denatured polyolefin or the like. The thermal bonding resin layers of flexible film 30 are set so as to face each other, and the periphery of a part where the electrode laminate body is contained is thermally bonded, so that the outer container is formed. A resin layer of a nylon film, a polyester film or the like can be provided on the surface of the outer container, which is the surface on the side opposite to the surface for the formation of the thermal bonding resin layer.

A terminal composed of aluminum or an aluminum alloy can be used as positive electrode terminal 11, a terminal composed of copper or a copper alloy, or a terminal composed of copper or a copper alloy and plated with nickel, or the like, can be used as negative electrode terminal 16. The other end sides of terminals 11, 16 are led out of the outer container. A thermal bonding resin can be previously provided at spots of terminals 11, 16 corresponding to the thermal bonding part of the peripheral part of the outer container.

For insulating member 40 formed so as to cover border part 4 between the applied part and non-applied part of positive electrode active material layer 2, polyimide, glass fiber, polyester, polypropylene, or materials containing them can be used. Insulating member 40 can be formed by bonding a tape-like resin member to border part 4 by heat, or by applying a gel-like resin on border part 4 and then drying the resin.

Here, it is not always necessary that the edges of first active material layer 2a and second active material layer 2b of positive electrode active material layer 2 are disposed on positive electrode current collector 3 parallel to each other. At border part 4 between the applied part and non-applied part of positive electrode 1, or at the end part of negative electrode 6, the end parts may have rounded curve shapes, instead of linear shapes orthogonal to the direction in which current collectors 3, 8 extend. Needless to say, each of positive electrode active material layer 2 and negative electrode active material layer 7 may have unavoidable slopes, unevennesses, rounds, or the like in the layers that are caused, for example, by the variation or layer formation capability in the production.

### Production Method for Secondary Battery

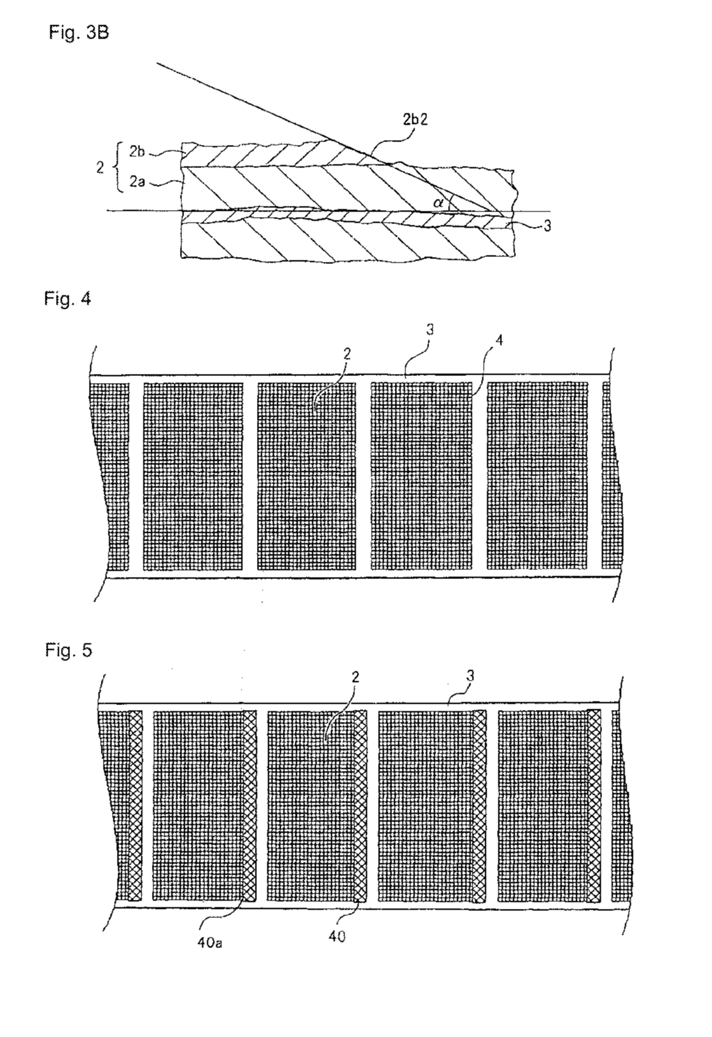

First, as shown in FIG. 4, first active material layer 2a is applied on long strip-shaped positive electrode current collector 3 for producing positive electrodes (positive electrode sheets) 1, and subsequently, second active material layer 2b is formed, so that positive electrode active material layer 2 is formed. Positive electrode active material layer 2 is formed on both surfaces of positive electrode current collector 3. Although not clear in FIG. 4, the detailed shape and dimensions of positive electrode active material layer 2 have been described with reference to

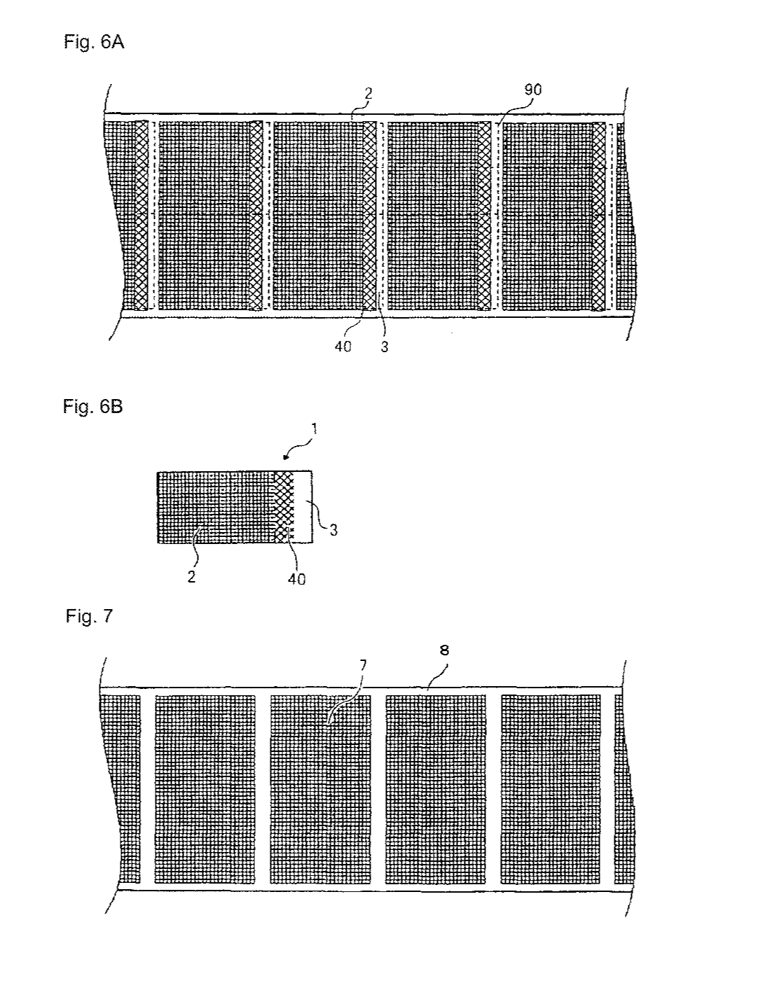

FIGS. 3A and 3B. Next, as shown in FIG. 5, insulating member 40 is formed so as to cover border part 4. One end part 40a of insulating member 40 is positioned on single-layer part S of positive electrode active material layer 2, and the other end part is positioned on the non-applied part (see FIGS. 2 and 3A). If the thickness of insulating member 40 is small, there is a fear that the insulation property cannot be sufficiently secured, and therefore, it is preferable that the thickness be 10 μm or greater. Further, if the thickness of insulating member 40 is too large, the effect of reducing the increase in the thickness of the electrode laminate body according to the present invention is not sufficiently exerted, and therefore, it is desirable that insulating member 40 be smaller than the average thickness of multi-layer part M of positive electrode active material 2. The thickness of insulating member 40, preferably, is 90% or less of the average thickness of multi-layer part M of positive electrode active material 2, and more preferably, is 60% or less of the average thickness of multi-layer part M. The end part of the applied part (first active material layer 2a) at border part 4 with the non-applied part may rise substantially perpendicularly with respect to positive electrode current collector 3, or may slope as shown in FIGS. 2 and 3A. Thereafter, for obtaining positive electrodes 1 to be used in individual laminated type batteries, positive electrode current collector 3 is cut out and divided along cutting lines 90 shown by broken lines in FIG. 6A, so that positive electrode 1 having a desired size shown in FIG. 6B is obtained. Cutting lines 90 are hypothetical lines, and are not actually formed.

Further, as shown in FIG. 7, negative electrode active material layer 7 is intermittently applied on both surfaces of large-area negative electrode current collector 8 for producing negative electrodes (negative electrode sheets) 6. Negative electrode active material layer 7 has a single-layer structure, and the end part (the end part of the applied part) thereof may slope slightly, or may rise substantially perpendicularly with respect to negative electrode current collector 8.

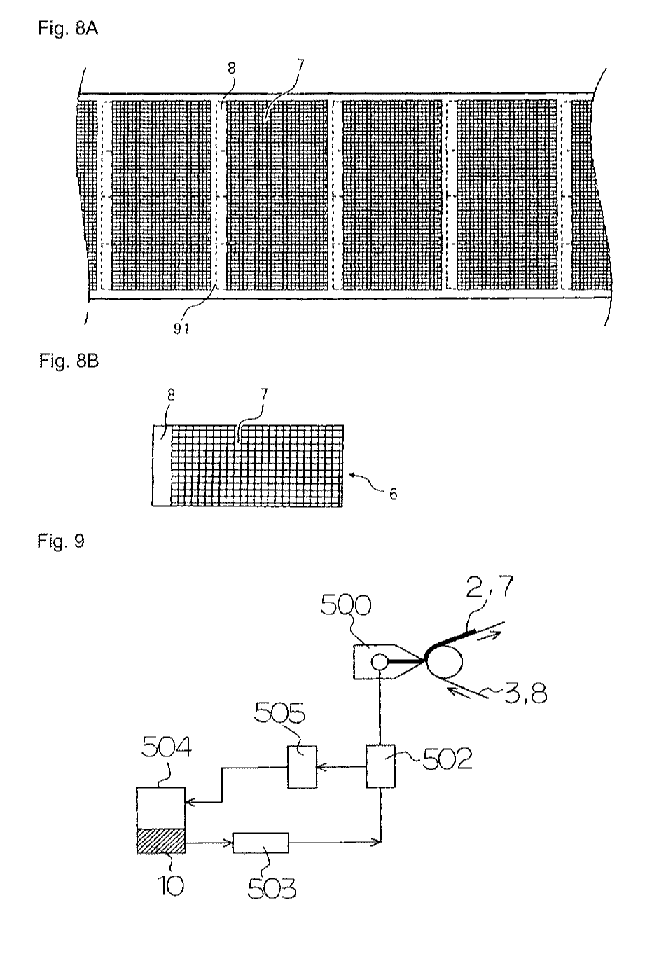

Thereafter, for obtaining negative electrodes 6 to be used in individual laminated type batteries, negative electrode current collector 8 is cut out and divided along cutting lines 91 shown by broken lines in FIG. 8A, so that negative electrode 6 having a desired size shown in FIG. 8B is obtained. Cutting lines 91 are hypothetical lines, and are not actually formed.

Positive electrode 1 shown in FIG. 6B and negative electrode 6 shown in FIG. 8B formed in this way are alternately laminated with separator 20 interposed therebetween, and positive electrode terminal 11 and negative electrode terminal 16 are connected, so that the electrode laminate body shown in FIG. 2 is formed. The electrode laminate body, together with the electrolyte solution, is contained in the outer container formed of flexible film 30, and sealing is performed, so that secondary battery 100 shown in FIGS. 1A and 1B is formed.

According to secondary battery 100, the increase in thickness due to insulating member 40 formed so as to cover border part 4 between the applied part and non-applied part of positive electrode 1 is absorbed (cancelled) by the smallness in thickness of single-layer part S of positive electrode active material layer 2 compared to multi-layer part M, and using an electrode laminate body that is thick in parts can be avoided. Therefore, it is possible to apply uniform pressure to the electrode laminate body to secure it, and it is possible to prevent the decrease in quality, as exemplified by the variation in electric characteristic and by a decrease in cycle characteristics.

Here, in the example shown in FIG. 8B, the applied parts on both surfaces of negative electrode 6 are terminated at a position that faces the non-applied part (positive electrode tab) of positive electrode 1, and as shown in FIG. 2, a configuration in which negative electrode active material 7 is present on the front and back sides of negative electrode current collector 8 and the non-applied part is not present at the position that faces the non-applied part of positive electrode 1 is adopted. However, it is allowable to adopt a configuration in which the non-applied part is present at the position on negative electrode 6 that faces the non-applied part of positive electrode 1. Here, as shown in FIG. 8B, a non-applied part that is an negative electrode tab is provided on the end part of negative electrode 6 that does not face the non-applied part of positive electrode 1.

In the present invention, unless otherwise specified, the thickness, distance or the like of each member means the average value of the measurement values at three or more arbitrary places.

### Detailed Electrode Making Method

A detailed electrode making method of the above-described production method for the secondary battery in the present invention will be described.

As an apparatus for forming the active material layer having a multi-layer structure (two-layer structure) on the current collector, a doctor blade, a die coater, a gravure coater, apparatuses that carry out various application methods such as a transfer technique and a deposition technique, and combinations of the application apparatuses can be used. In the present invention, it is preferable to use the die coater, to accurately form the application end part of the active material. The application technique for the active material with the die coater falls roughly into two kinds: a continuous application technique of forming the active material continuously along the longitudinal direction of a long current collector and an intermittent application technique of forming an active material applied part and an active material non-applied part alternately and repeatedly along the longitudinal direction of the current collector.

FIG. 9 is a diagram showing an exemplary configuration of a die coater that performs the intermittent application. As shown in FIG. 9, on a slurry flow path of the die coater that performs the intermittent application, there are die head 500, application valve 502 linked with die head 500, pump 503, and tank 504 in which slurry 10 is stored. Further, there is return valve 505 between tank 504 and application valve 502. In the configuration, a motor valve, a solenoid valve, an air valve and other various valve devices can be used as the application valve. Here, particularly, it is preferable to use the motor valve as application valve 502, to accurately control the shape and dimensions of the end part of the applied part of the upper layer (second active material layer). The motor valve can accurately change the open-close state of the valve, even during the application of slurry 10. Accordingly, by keeping the viscosity of slurry 10 at 5000 to 1000 cps (measured at 20° C. with an E-type viscometer), it is possible to form an angle of 20 degrees or greater, as the angle between an applied surface at an application starting end part for the active material and the slope part.

Further, also by using the continuous application technique, the first active material layer is applied on the long current collector side and is dried, and thereafter, the second active material layer can be applied. In this case, the slurry having a viscosity of 5000 to 10000 cps may be applied such that the planar position of the end part (termination position) of the second active material layer does not coincide with the planar position of the end part (termination position) of the first active material layer and is deviated in the direction perpendicular to the longitudinal direction of the current collector.

In each intermittent application technique and each continuous application technique, it is possible to extremely reduce the distance (the length of the slope part along the longitudinal direction of the current collector) for transitioning from the average thickness at single-layer part

S, where any one of the first active material layer and the second active material layer is formed, to the average thickness at multi-layer part M where both active material layers are laminated. For example, in the case of forming a single-layer active material layer having a desired thickness by controlling the flow rate of slurry 10 to be discharged from the die head, or the like, the distance necessary for transitioning from a thin part to a thick part of the active material layer is about 2 to 20 mm. However, according to the present invention, it is possible to reduce the distance (the length of the slope part along the longitudinal direction of the current collector) necessary for the same thickness transition, to about 0.01 mm to 2 mm. Considering the stability of the slope part and the energy density per unit volume of the battery electrode assembly, the distance (the length of the slope part along the longitudinal direction of the current collector), preferably, is 0.01 to 0.5 mm, and more preferably, is 0.01 to 0.1 mm.

Here, the thickness of the active material layer may be an arbitrary value, and is not particularly limited. In the case of the use for a portable electronic device, an electric bicycle, an electric assist bicycle, a stationary charger, an electric vehicle, a hybrid vehicle or the like, from the standpoint of battery capacity and weight, it is preferable that the active material layer that is positioned on at least one surface of the current collector be about 5 to 200 μm in thickness. Here, the numerical value shows the thickness of the active material layer that is positioned on one surface of the current collector, and does not show the total thicknesses of the active material layers positioned on both surfaces of the current collector.

When the difference in thickness between multi-layer part M where both of the first active material layer and the second active material layer are laminated and single-layer part S where any one active material layer is formed is larger than the thickness of insulating member 40, it is possible to prevent an increase in the thickness of the battery electrode assembly due to insulating member 40, resulting in a very high effect. However, even when the difference in thickness between multi-layer part M and single-layer part S is smaller than the thickness of insulating member 40, the local increase in the thickness of the battery electrode assembly can be reduced to a small amount and some positive effect is obtained, for example if the difference in thickness between multi-layer part M and single-layer part S is 50% or more of the thickness of insulating member 40. On the other hand, even when the difference in thickness between multi-layer part M and single-layer part S is larger, a large thickness of multi-layer part M is not preferable because the entire battery electrode assembly becomes thick although the local increase in thickness can be prevented, and excessive thinness of single-layer part S is not preferable because the original function of the active material becomes insufficient. From such a standpoint, the difference in thickness between multi-layer part M and single-layer part S, preferably, is equal to or less than the thickness resulting from adding 50 μm to the thickness of insulating member 40, and more preferably, is equal to or less than the thickness resulting from adding 25 μm to the thickness of the insulating member. Considering these requirements, in the case of using an insulating member having a thickness of 20 μm, the difference in thickness between multi-layer part M and single-layer part S, preferably, is 10 μm to 70 μm, and more preferably, is 20 μm to 45 μm. Further, in the case of using an insulating member having a thickness of 40 μm, the difference in thickness between multi-layer part M and single-layer part S, preferably, is 20 μm to 90 μm, and more preferably, is 40 μm to 65 μm.

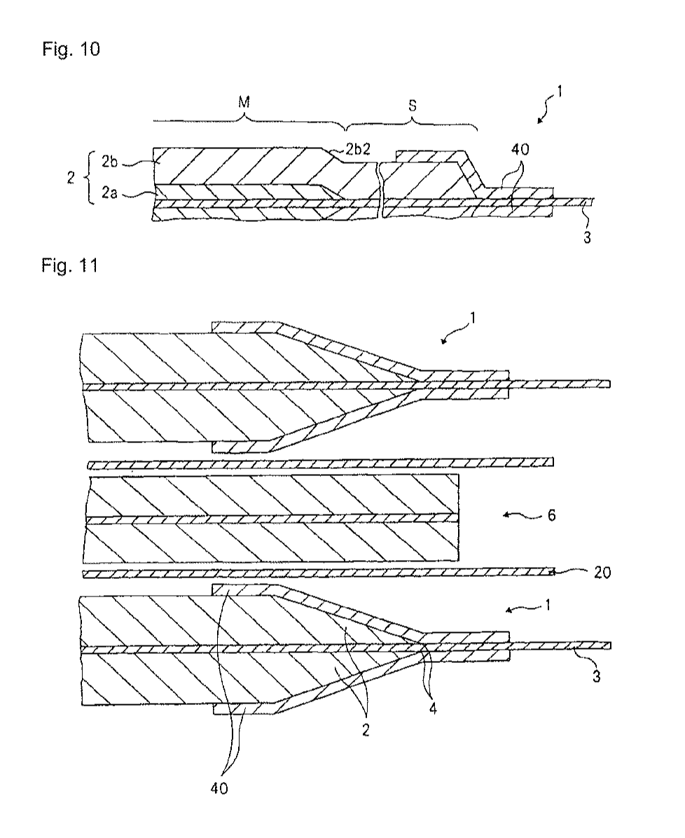

The distance between the end part (termination position) of the applied part of the first active material layer and the end part (termination position) of the applied part of the second active material layer, that is, the length of single-layer part S where the insulating member is formed, may be an arbitrary value, and is not particularly limited. Taking into account the energy density per unit volume of the battery electrode assembly, the distance, preferably, is 0.5 to 5 mm, and more preferably, is 0.5 to 3 mm. In this case, it is allowable to arbitrarily select whether the end part of the applied part of the second active material layer is positioned on the first active material layer such that single-layer part S is configured by the first active material layer similarly to the exemplary embodiment (FIGS. 2 to 3) described above, or whether the end part of the applied part of the second active material layer is positioned on the current collector beyond the end part of the applied part of the first active material layer such that single-layer part S is configured by the second active material layer similarly to another exemplary embodiment (FIG. 10) described later. However, for further shortening the transition distance from thin single-layer part S to thick multi-layer part M, it is preferable that the end part of the applied part of the second active material layer be positioned on the first active material layer such that single-layer part S is configured by the first active material layer. Such a configuration is effective, particularly, when the transition distance from thin single-layer part S to thick multi-layer part M is reduced to 0.5 mm or less.

The termination position (the planar position of the end part of the applied part) of each active material layer may be different or may be identical between both surfaces of the current collector.

### Exemplary Modification

As an exemplary modification of the above-described exemplary embodiment, it is possible to adopt a configuration in which any one or both the first active material layer and the second active material layer include one or more kinds of fillers such as alumina, titania, zirconia and magnesia, ceramics to be obtained from these raw materials or combinations of them. Thereby, it is possible to enhance the heat resistance and safety when a short circuit occurs in the battery. This is because the inclusion of a heat-resistant filler and the like enhances heat resistance, and this is because the active material layer surface near the end part of the insulating member, to which particularly great stress is added by the heat shrinkage of the insulating member disposed at the border part between the applied part and non-applied part (the part where the current collector is exposed) of the active material when heat is added, is positioned at a part where the thickness from the current collector surface is small so that the active material layer surface is unlikely to make contact with the facing electrode. Furthermore, when any one of the first active material layer and the second active material layer contains a heat-resistant material and the other does not contain heat-resistant material or contains a smaller amount of heat-resistant material than the one active material layer, it is possible to minimize the decrease in the amount of active material corresponding to the content ratio of the heat-resistant material, and it is possible to reduce, to the minimum, the decrease in energy density that results from the heat-resistant material.

Specifically, a configuration for dispersing alumina particles in the second active material layer that is the upper layer (surface layer) can be adopted (other configurations and production methods are the same as those in the above description, and therefore, descriptions thereof are omitted).

In order that the active material layer that contains a heat-resistant material obtain the heat resistant effect, a thickness corresponding to the capacity per unit weight of the active material is required, from the standpoint of safety. When the end part of the second active material layer is positioned on the first active material layer and the second active material layer contains heat-resistant material (for example, alumina) as described in the exemplary modification, the transition distance from the end of the applied part (termination position) of the second active material layer to the average thickness part of the multi-layer part is very short. Therefore, the part where the thickness of the layer containing the heat-resistant material is thin is small, and the safety effect is very high.

### Other Exemplary Embodiment

In the exemplary embodiment shown in FIGS. 2 to 3, the end part of the applied part of second active material layer 2b is positioned on first active material layer 2a, and the single-layer part is configured by first active material layer 2a. However, as shown in FIG. 10, second active material layer 2b may extend beyond the end part of the applied part of first active material layer 2a, and the single-layer part may be configured by second active material layer 2b.

In that case, slope part 2b2 of multi-layer part M that extends from a border part with single-layer part S is provided at an intermediate part of second active material layer 2b, and the shape and dimensions are roughly similar to those of the end part of the applied part of first active material layer 2a positioned at the lower layer.

As an example, the average thickness of first active material layer 2a is 0.04 mm, and the average thickness of second active material layer 2b is 0.1 mm. Accordingly, the average thickness of multi-layer part M is 0.14 mm. The length of slope part 2b2 along the longitudinal direction of positive electrode current collector 3 is 0.06 mm, and the length of single-layer part

S along the longitudinal direction of positive electrode current collector 3 is 1 mm. Then, the thickness of insulating member 40 formed across single-layer part S and the non-applied part is 0.03 mm. In this configuration, at the part where insulating member 40 is positioned on positive electrode active material layer 2, the sum of the thickness of positive electrode active material layer 2 (single-layer part S formed of second active material layer 2b) and the thickness of insulating member 40 is 0.13 mm, and is smaller than the average thickness (0.14 mm) of multi-layer part M of positive electrode active material layer 2. Thus, positive electrode 1 is not thick in part at the location where insulating member 40 is disposed. Therefore, it is possible to reduce a decrease in energy density per volume and to apply uniform pressure to the battery electrode assembly, and it is possible to prevent a decrease in the quality of the battery, as exemplified by the variation in electric characteristic and by a decrease in cycle characteristic. Here, slope part 2b2 and single-layer part S have a lower density than multi-layer part M.

In the above description, the configuration in which insulating member 40 is provided on positive electrode 1 and in which the insulating member is not provided on negative electrode 6 and in which positive electrode active material layer 2 has the multi-layer structure of first active material layer 2a and second active material layer 2b and negative electrode active material layer 7 has the single-layer structure has been mainly described. However, a configuration can be adopted in which insulating member 40 is provided on negative electrode 6 and the insulating member is not provided on positive electrode 1 and in which positive electrode active material layer 2 has the single-layer structure and negative electrode active material layer 7 has the multi-layer structure of the first active material layer and the second active material layer. Further, a configuration can be adopted in which insulating member 40 is provided on both positive electrode 1 and negative electrode 6 and in which both positive electrode active material layer 2 and negative electrode active material layer 7 have the multi-layer structure of the first active material layer and the second active material layer. In each configuration, on the active material layer having the multi-layer structure, a part of the insulating member is disposed on single-layer part S, and at least some of the increase in thickness due to the insulating member is absorbed (cancelled) by the difference in thickness between multi-layer part M and single-layer part S, resulting in the effect of reducing an increase in the thickness of the battery electrode assembly.

The present invention is useful for the lithium-ion batteries and the production method therefore, and can also be effectively applied also to secondary batteries other than the lithium-ion battery and production methods therefore.

Thus, the present invention has been described with reference to some exemplary embodiments, but the present invention is not limited to the configurations of the above-described exemplary embodiments. For the configurations and details of the present invention, it is possible to make various modifications that can be understood by those in the art, within the scope of the technical idea of the present invention.

The present application claims priority based on Japanese Patent Application No. 2013-257197 filed on Dec. 12, 2013, and incorporates herein all the disclosure of Japanese Patent Application No. 2013-257197.

1. A secondary battery comprising a battery electrode assembly in which a positive electrode and a negative electrode are alternately laminated with a separator interposed therebetween,
each of said positive electrode and said negative electrode including a current collector and an active material layer formed on said current collector,
wherein in any one or both of said positive electrode and said negative electrode, said active material layer has a multi-layer structure that includes a first active material layer and a second active material layer, a part or a whole of said second active material layer being positioned on said first active material layer, a termination position of said first active material layer and a termination position of said second active material layer being deviated in a planar direction, an insulting member being disposed so as to cover a border part between an applied part and a non-applied part, the applied part being a part where said active material layer is formed, the non-applied part being a part where said active material layer is not formed

2-12. (canceled)

13. The secondary battery according to claim 1, wherein a difference between an average thickness at a multi-layer part where both said first active material layer and said second active material layer are laminated on said current collector and a thickness of said active material layer at a part where said insulating member is positioned on said active material layer being 50% or more of a thickness of said insulating member.

14. The secondary battery according to claim 13, wherein the sum of the thickness of said active material layer at the part where said insulating member is positioned on said active material layer and the thickness of said insulating member is smaller than the average thickness of said active material layer at the multi-layer part where both said first active material layer and said second active material layer are laminated on said current collector.

15. The secondary battery according to claim 13, wherein said active material layer having the multi-layer structure includes the multi-layer part and a single-layer part, the single-layer part being a part where any one of said first active material layer and said second active material layer is formed on said current collector and the single-layer part being thinner than the multi-layer part, wherein the multi-layer part includes a slope part that extends from a border position with the single-layer part.

16. The secondary battery according to claim 15, wherein an average angle of the slope part of said active material layer having the multi-layer structure with respect to said current collector is 20 degrees or greater.

17. The secondary battery according to claim 16, wherein the average angle of the slope part with respect to said current collector is 25 degrees or greater.

18. The secondary battery according to claim 15, wherein the slope part is provided in a range from the border position between the multi-layer part and the single-layer part to an average thickness part of the multi-layer part.

19. The secondary battery according to claim 15, wherein a length of the slope part in a longitudinal direction of said current collector is 0.2 mm or less.

20. The secondary battery according to claim 13, wherein the insulating member is formed across the single-layer part of said active material layer and the non-applied part.

21. A production method for a secondary battery, the production method comprising the steps of: forming a positive electrode by forming an active material layer for said positive electrode on both surfaces of a current collector for said positive electrode; forming an negative electrode by forming an active material layer for said negative electrode on both surfaces of a current collector for said negative electrode; laminating said positive electrode and said negative electrode alternately with a separator interposed therebetween; disposing an insulating member on any one or both of said positive electrode and said negative electrode such that said insulating member covers a border part between an applied part and a non-applied part, the applied part being a part where said active material layer is formed, the non-applied part being a part where said active material layer is not formed,
wherein in any one or both of the step of forming said positive electrode and the step of forming said negative electrode, a first active material layer is formed on said current collector, and thereafter, a second active material layer is formed to make a multi-layer structure such that a part or a whole of said second active material layer is positioned on said first active material layer and a termination position of said second active material layer is a position that is different in a planar direction from a termination position of said first active material layer.

22. The production method for the secondary battery according to claim 21, a difference between an average thickness at a multi-layer part where both said first active material layer and said second active material layer are laminated on said current collector and a thickness of said active material layer at a part where said insulating member is positioned on said active material layer is 50% or more of a thickness of said insulating member.

23. The production method for the secondary battery according to claim 22, wherein in any one or both of the step of forming said positive electrode and the step of forming said negative electrode, said first active material layer is formed on said current collector, and thereafter, said second active material layer is formed to make the multi-layer structure such that a part or a whole of said second active material layer is positioned on said first active material layer and the termination position of said second active material layer is the position that is different in the planar direction from the termination position of said first active material layer, and the sum of the thickness of said active material layer at the part where said insulating member is positioned on said active material layer and the thickness of said insulating member is smaller than the average thickness of said active material layer at the multi-layer part where both said first active material layer and said second active material layer are laminated on said current collector.

24. The production method for the secondary battery according to claim 22, wherein said active material layer having the multi-layer structure is formed such that said active material layer having the multi-layer structure includes the multi-layer part and a single-layer part, the single-layer part being a part where any one of said first active material layer and said second active material layer is formed on said current collector and the single-layer part being thinner than the multi-layer part, wherein the multi-layer part includes a slope part that extends from a border position with the single-layer part.

25. The production method for the secondary battery according to claim 22, wherein said second active material layer is formed by applying a mixture agent containing active material, a binder, and a solvent, and having a viscosity which is not less than 5000 cps and not more than 10000 cps.
